(19) United States
(12) Patent Application Publication
(10) Pub. No.: US 2013/0295336 A1
(43) Pub. Date: Nov. 7, 2013

(54) MIRROR-SURFACE SHEET COMPRISING TRANSPARENT PROJECTIONS HAVING AN INDEPENDENT STRUCTURE AND PRODUCTION METHOD THEREFOR

(71) Applicants: Jung-Eun Ha, Jinhae-si (KR); Moon-Ki Yea, Ulsan (KR); Ji-Yong Park, Ulsan (KR)

(72) Inventors: Jung-Eun Ha, Jinhae-si (KR); Moon-Ki Yea, Ulsan (KR); Ji-Yong Park, Ulsan (KR)

(73) Assignee: LG HAUSYS, LTD., Seoul (KR)

(21) Appl. No.: 13/979,760

(22) PCT Filed: Feb. 17, 2012
(86) PCT No.: PCT/KR2012/001187

§ 371 Date: Jul. 15, 2013

(30) Foreign Application Priority Data
Feb. 21, 2011 (KR) 10-2011-0015140

(51) Int. Cl. G02B 5/08

(52) U.S. Cl. CPC G02B 5/08
USPC 428/172; 427/164

(57) ABSTRACT

Disclosed is a minor-surface sheet comprising transparent projections having an independent structure, and the minor-surface sheet has outstanding resistance to fingerprints even after formation by deep drawing and gives an appealing impression by imparting an impression of depth. The mirror-surface sheet according to the present invention, which has outstanding resistance to fingerprints and can impart an extreme impression of depth, comprises: a transparent film layer; a printed layer which is formed on the lower part of the transparent film layer; and a transparent projection layer which comprises a plurality of transparent projections that are attached, spaced apart from each other on the upper part, of the transparent film layer.

### TECHNICAL FIELD

The present invention relates to a mirror-surface sheet which permits deep-drawing, and more particularly, to a mirror-surface sheet that includes transparent protrusions of an independent structure on a transparent film layer to provide outstanding fingerprint repellency while maintaining an appealing impression of a three-dimensional and deep structure even at a severely curved section.

### BACKGROUND ART

Mirror-surface sheets used for decoration of kitchens generally have low resistance to fingerprints, and such a problem of the mirror-surface sheets becomes severe as colors of the mirror-surface sheets become dark. Currently, mirror-surface sheets generally have a monochromatic pearl or wood pattern and have been consistently required to provide high repellency to fingerprints including spots by perspiration and oil while exhibiting a luxurious appearance by providing an impression of depth as in glass according to market trend.

In existing methods for realizing surface protection and gloss of the mirror-surface sheet, a transparent protective film, a special treatment agent and the like are used. Basically, fingerprint repellency of the mirror-surface sheet increases as the surface of the mirror-surface sheet approaches a matt surface. However, since the mirror-surface sheet requires the same surface conditions as those of glass, the use of a matt film or treatment agent has a limit Generally, a mirror layer is formed thereon using a gloss type treatment agent capable of realizing fingerprint repellency.

As existing measures, a method of preventing fingerprints from sticking to the sheet surface, a method of allowing fingerprints to spread on the sheet surface over time so as not to be visually recognized, and the like are used in the art.

As the method of preventing fingerprints from sticking on the sheet surface, a surface treatment agent such as fluorine compounds is known in the art, and as the method of concealing fingerprints, a concealing film comprising a bio-induced lipid component causing the fingerprints and a lipophilic component is known in the art. Currently, although the development of such a mirror-surface treatment agent is actively carried out, there is a limit in realization of fingerprint repellency or concealment using a typical treatment agent.

A conventional minor-surface sheet provides fingerprint repellency using the treatment agent. The treatment agent for preventing fingerprints from sticking to the surface of the mirror-surface sheet can reduce attachment of the fingerprints. However, in the case where the treatment agent fails to completely prevent the fingerprints from sticking to the sheet surface, spots caused by the fingerprints stuck to the sheet surface become apparent. For the fingerprint concealing film, it takes a long time to conceal the fingerprints on the sheet surface. In addition, a sheet having a treatment agent coating layer has a limit in terms of shaping.

Further, since the sheet having the treatment agent coating layer formed thereon can undergo cracking of the coating layer upon shaping, the sheet is not familiar with deep drawing and is restrictively used for a part which is not severely curved upon shaping.

In another method for providing fingerprint repellency, a convex-concave portion is formed on the surface of the mirror-surface sheet such that fingerprint sebum sticking to the surface of the minor-surface sheet can rapidly transfer into the convex-concave portion, thereby not being visible to the human eye. Although this method provides an advantage of rapid concealment of fingerprints, the convex-concave portion can be stretched and removed upon deep drawing, thereby making it difficult to conceal the fingerprints. This results in restriction of application of the minor-surface sheet.

### DISCLOSURE

### Technical Problem

An aspect of the present invention is to provide a mirror-surface sheet which exhibits an appealing mirror surface effect and is capable of maintaining fingerprint repellency even after deep drawing.

Another aspect of the present invention is to provide a method for manufacturing a minor-surface sheet which includes transparent protrusions of an independent structure capable of maintaining fingerprint repellency on a surface of a formed article having a severely curved section.

### Technical Solution

In accordance with one aspect of the present invention, a mirror-surface sheet includes a transparent film layer, a print layer formed on a lower portion of the transparent film layer, and a transparent protrusion layer formed on an upper portion of the transparent film layer and comprising a plurality of transparent protrusions separated from each other.

In accordance with another aspect of the present invention, a method for manufacturing a minor-surface sheet includes: (a) preparing a transparent film layer, (b) forming a print layer on a lower portion of the transparent film layer; and (c) forming a transparent protrusion layer by attaching a plurality of transparent protrusions to an upper portion of the transparent film layer.

### Advantageous Effects

As such, the minor-surface sheet according to the present invention is capable of exhibiting an appealing impression of depth due to binocular disparity between the transparent protrusion layer and the print layer. In addition, the plural transparent protrusions of the minor-surface sheet are independently constructed to form the transparent protrusion layer, thereby preventing removal of a concave-convex shape even by deep drawing. Further, the mirror-surface sheet according to the present invention can maintain fingerprint repellency.

Furthermore, in the method according to the present invention, the plurality of transparent protrusions is attached to an upper portion of the transparent film layer to form the transparent protrusion layer, whereby the mirror-surface sheet can provide excellent fingerprint repellency even at a curved section of an article to which the mirror-surface sheet is applied.

### DESCRIPTION OF DRAWINGS

FIG. 1 is a sectional view of a minor-surface sheet including a transparent protrusion layer, a transparent film layer and a print layer in accordance with one embodiment of the present invention.

FIG. 2 is a sectional view of a conventional sheet in which a convex-concave portion is integrally formed with a curable resin layer.

### BEST MODE

The above and other aspects, features, and advantages of the present invention will become apparent from the detailed description of the following embodiments in conjunction with the accompanying drawings. It should be understood that the present invention is not limited to the following embodiments and may be embodied in different ways, and that the embodiments are provided for complete disclosure and a thorough understanding of the present invention by those skilled in the art. The scope of the present invention is defined only by the claims. Like components will be denoted by like reference numerals throughout the specification.

Next, a minor-surface sheet and a method for manufacturing the same according to the present invention will be described with reference to the accompanying drawings.

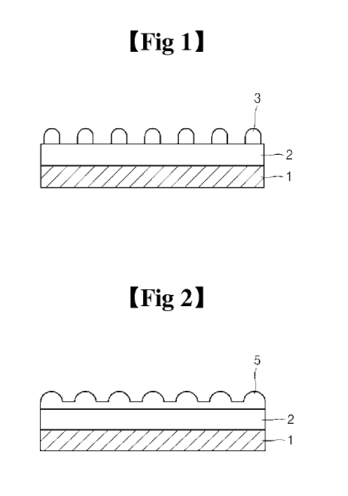

FIG. 1 is a sectional view of a minor-surface sheet including a transparent protrusion layer, a transparent film layer 2 and a print layer 1 in accordance with one embodiment of the present invention

Referring to FIG. 1, the minor-surface sheet according to the present embodiment includes the transparent film layer 2, the print layer 1 formed on a lower portion of the transparent film layer, and a transparent protrusion layer formed on an upper portion of the transparent film layer and comprising a plurality of transparent protrusions 3 separated from each other.

The transparent film layer 2 is generally formed by extrusion or calendering, without being limited thereto.

The transparent film layer 2 may be formed of any typical transparent film without limitation. Preferably, the transparent film layer 2 is formed of a polyester resin, such as polycarbonate (PC) or polyethylene terephthalate glycol (PET-G).

The print layer 1 is formed on a lower portion of the transparent film layer 2. Here, it should be noted that the print layer 1 is not necessarily formed on a lower surface of the transparent film layer in terms of the structure of the mirror-surface sheet. In other words, another component may be interposed between the transparent film layer 2 and the print layer 1.

The print layer 1 may be formed by gravure printing an ink. Alternatively, the print layer 1 may be formed by deposition of metal powder to provide a pattern of a metallic appearance. Here, it should be understood that the present invention is not limited to these method in formation of the print layer 1.

The mirror-surface sheet according to the present embodiment includes the transparent protrusion layer formed one the upper portion of the transparent film layer 2 and comprising the plurality of transparent protrusions 3 separated from each other.

The transparent protrusion layer comprises the plurality of transparent protrusions 3 separated from each other on the transparent film layer. The transparent protrusions 3 are independently constructed and attached to the upper portion of the transparent film layer 2 while being separated from each other. Herein, the attachment of the transparent protrusions 3 means that the transparent protrusions are secured to the upper portion of the transparent film layer 2 by bonding or adhesion. In addition, the transparent protrusions 3 are not necessarily attached to the surface of the transparent film layer 2, and may be attached to a surface of another component which can be formed on the upper portion of the transparent film layer 2. Each of the transparent protrusions 3 is not integrally formed with the surface of the mirror-surface sheet. Each of the transparent protrusions 3 is separately fabricated and attached to the surface of the mirror-surface sheet. Then, such a plurality of transparent protrusions 3 is congregated to form the transparent protrusion layer.

The transparent protrusions 3 may be formed of a curable polymer resin, without being limited thereto. Further, the transparent protrusions 3 may have any shape depending on the purpose of the sheet, without being limited to a particular shape. The transparent protrusions 3 may have any shape including a semi-circular shape, a star shape, a rhombus shape, a trapezoidal shape, a triangular shape and a stripe shape.

FIG. 2 is a sectional view of a conventional sheet having a convex-concave portion 5 formed on a surface thereof. Referring to FIG. 2, the conventional sheet includes a curable resin layer formed on the surface thereof and including the convex-concave portion 5 to improve fingerprint repellency. When the hand is brought into contact with the surface of the conventional sheet, fingerprint sebum (including spots by perspiration, oil, and the like) can rapidly transfer into the convex-concave portion, thereby not being visible to the human eye. However, when the curable resin layer of the sheet is integrally formed with the convex-concave portion 5, the convex-concave portion 5 can be stretched and disappear upon formation of a severely curved section as in deep drawing.

To solve such a problem, the mirror-surface sheet according to the present invention includes the transparent protrusion layer, which comprises the plurality of transparent protrusions 3 attached to the surface thereof.

The conventional sheet having a convex-concave portion has a problem in that the convex-concave portion is demolished upon deep drawing, thereby causing visual deformation and making it difficult to maintain concealment of fingerprints. On the contrary, in the mirror-surface sheet according to the present invention, the plurality of transparent protrusions is independently constituted and thus can maintain the shapes thereof even after deep drawing. Thus, the mirror-surface sheet according to the present invention can maintain a three-dimensional appearance by binocular disparity while providing excellent effects in concealment of fingerprints.

A method for manufacturing a mirror-surface sheet according to the present invention includes (a) preparing a transparent film layer, (b) forming a print layer on a lower portion of the transparent film layer; and (c) forming a transparent protrusion layer by attaching a plurality of transparent protrusions to an upper portion of the transparent film layer

Step (a) is a process of preparing the transparent film layer 2 to be included in the mirror-surface sheet. The transparent film layer 2 may be formed of any transparent film without limitation. Preferably, the transparent film layer 2 is formed of a polyester resin, such as polycarbonate (PC) or polyethylene terephthalate glycol (PET-G).

The transparent film layer 2 may be formed of such a polymer resin composition by extrusion or calendering.

Step (b) is a process of forming the print layer 1 on the lower portion of the transparent film layer 2. The print layer 1 may be formed by printing a pattern on a lower surface of the transparent film layer 2. Here, it should be understood that the lower portion of the transparent film layer 2 may include another component as needed, and the print layer may be formed on an upper portion or a lower portion of the other component.

The print layer 1 may be formed by printing a variety of patterns via gravure printing. Alternatively, the print layer 1 may be formed by deposition of metal powder to provide a pattern of a metallic appearance.

Step (c) is a process of forming a transparent protrusion layer by attaching a plurality of transparent protrusions to an upper portion of the transparent film layer 2.

Herein, the transparent protrusions may be attached to the upper portion of the transparent film layer 2 by any method, such as bonding or adhesion. In addition, the transparent protrusions 3 are not necessarily attached to the surface of the transparent film layer 2 and may be attached to a surface of another component which can be formed on the upper portion of the transparent film layer 2, as needed.

Step (c) may include: (c1) preparing a frame formed with grooves having shapes of the transparent protrusions, and filling the grooves with a liquid curable resin, (c2) bring a surface of the frame having the grooves thereon into contact with the transparent film to allow the curable resin to be brought into contact with a surface of the transparent film; and (c3) curing the curable resin in a state of contacting the transparent film.

Preferably, the method further includes (c11) removing the curable resin from a portion of the surface of the frame, on which the grooves are not formed, between step (c1) and step (c2).

In step (c1), the frame formed with the grooves having the shapes of the transparent protrusions is prepared. The frame may be made of a metallic material. Then, the grooves are filled with the liquid curable resin. As for the curable resin, any transparent curable polymer resin may be used without limitation.

In step (c11), the curable resin is removed from the portion of the surface of the frame, on which the grooves are not formed. It is difficult to fill only the grooves of the frame with the curable resin in a manufacturing process. Thus, the curable resin is deposited over the surface of the frame so as to allow the grooves to be filled with the curable resin. Then, the curable resin is removed from the surface of the frame such that the curable resin can remain only in the grooves.

In step (c2), the transparent film is brought into contact with the frame to allow the curable polymer resin to be brought into contact with the surface of the transparent film.

In step (c3), the curable polymer resin is cured in a state of contacting the transparent film as obtained in step (c2). Here, curing is preferably performed by ultraviolet or electron beam irradiation, without being limited thereto. When the curable resin is cured in the state of contacting the transparent film, the curable resin can be cured while bonding to the transparent film.

When the curable resin is sufficiently cured, the resin is removed from the frame. The curable resin is cured into the shapes of the transparent protrusions and removed from the frame while bonded to the upper portion of the transparent film. The transparent protrusions are independently bonded to the surface of the transparent film and congregate to form the transparent protrusion layer.

As described above, the process of forming the transparent protrusion layer through steps (c1) to (c3) integrates a process of forming the transparent protrusions and a process of bonding the transparent protrusions into a single process, thereby providing advantages in terms of time and cost.

Alternatively, the transparent protrusion layer may be formed by forming a transparent bonding layer on the transparent film layer 2 and arranging the plurality of transparent protrusions 3 on the bonding layer. The bonding layer may include a polyurethane or polyester resin, without being limited thereto.

### EXAMPLE

### Example 1

A polymer resin composition mainly composed of polyethylene terephthalate glycol (PET-G) was heated to a melting point or more and subjected to extrusion to prepare a 50 μm thick transparent film layer.

A metal frame having semispherical grooves was prepared and the grooves were filled with a liquid acrylic resin. Then, the resin was removed from a portion of the metal frame other than the semispherical grooves, and the transparent film layer was then brought into contact with the surface of the frame. Here, the transparent film layer was brought into the surface of the frame such that the acrylic resin could be brought into contact with the surface of the transparent film layer. The frame and the transparent film layer covering the frame were passed through a UV curing machine to cure the acrylic resin within the grooves of the frame. As a result, the transparent protrusion layer was formed on the surface of the transparent film layer.

Then, a pattern was printed on the rear side of the transparent film layer using an ink for gravure printing to form a print layer, thereby preparing a minor-surface sheet.

### Example 2

A polymer resin composition mainly composed of polyethylene terephthalate glycol (PET-G) was heated to a melting point or more and subjected to extrusion to prepare a 50 μm thick transparent film layer. Then, a pattern was printed on the rear side of the transparent film layer using an ink for gravure printing to form a print layer, thereby preparing a mirror-surface sheet. A bonding layer was formed on the transparent film layer using a polyester bonding agent. A plurality of transparent protrusions was arranged on the bonding layer to form a transparent protrusion layer, thereby preparing a minor-surface sheet.

### Example 3

A polymer resin composition mainly composed of polyethylene terephthalate glycol (PET-G) was heated to a melting point or more and subjected to extrusion to prepare a 50 μm thick transparent film layer. Then, a pattern was formed on the rear side of the transparent film layer by depositing chromium, aluminum, and nickel powder thereon to form a print layer. A plurality of transparent protrusions was dipped in a resin composition containing a polyester bonding agent, and arranged on the transparent film layer to form a transparent protrusion layer. Through these processes, a mirror-surface sheet including the print layer, the transparent film layer, and the transparent protrusion layer stacked from the bottom of the sheet was prepared.

### Comparative Example 1

A transparent film layer and a print layer were formed in the same manner as in Example 1, and a curable resin layer integrally formed with a convex-concave shape was formed on the transparent film. The curable resin layer was formed of a polymer resin mainly composed of PET-G. This layer was cured by UV irradiation, thereby forming a mirror-surface sheet in which the convex-concave portion is integrally formed with the curable resin layer.

### Comparative Example 2

A transparent film layer and a print layer were formed in the same manner as in Example 1, and a PET-G-based resin layer was formed on the transparent film. Then, a surface treatment layer was formed on the surface of the sheet using a fluorine compound containing an acrylic composition and was subjected to UV curing to form a mirror-surface sheet.

### Experimental Example

Each of the mirror-surface sheets prepared in the examples and the comparative examples was subjected to deep drawing for application to an interior decoration article. Results are shown in Table 1. A curved section of the article was evaluated as to fouling resistance (fingerprint repellency), durability and an impression of depth (aesthetic appearance) of the sheets through observation by the naked eye, and evaluation results were graded as good (∘), normal (Δ), and poor (×).

TABLE 1

| | Fouling | | Impression |
|---|---|---|---|
| | resistance | Durability | of depth |
| Example 1 | ∘ | ∘ | ∘ |
| Example 2 | ∘ | ∘ | ∘ |
| Example 3 | ∘ | ∘ | ∘ |
| Comparative Example 1 | x | Δ | Δ |
| Comparative Example 2 | Δ | x | Δ |

As can be seen from Table 1, for the mirror-surface sheets of Examples 1, 2 and 3, the plurality of independent transparent protrusions conceal fingerprints even at a severely curved section, thereby providing good fouling resistance. On the contrary, the sheet of Comparative Example 1 did not maintain fingerprint repellency due to stretching of the convex-concave portion at a curved section. The sheet of Comparative Example 2 could maintain more or less fingerprint repellency due to the surface treatment layer, but suffered from deterioration in durability due to cracking of the surface treatment layer.

Further, the mirror-surface sheets of Examples 1, 2 and 3 exhibited a good impression of depth due to binocular disparity between the transparent protrusion layer and the print layer, whereas the mirror-surface sheet of Comparative Example 1 did not provide an impression of depth due to stretching of the convex-concave portion at the curved section.

Although some embodiments have been described herein, it will be understood by those skilled in the art that these embodiments are provided for illustration only, and various modifications, changes, alterations and equivalent embodiments can be made without departing from the scope of the present invention. Therefore, the scope and spirit of the present invention should be defined only by the accompanying claims and equivalents thereof.

1. A minor-surface sheet comprising:
a transparent film layer;
a print layer formed on a lower portion of the transparent film layer; and
a transparent protrusion layer formed on an upper portion of the transparent film layer and comprising a plurality of transparent protrusions separated from each other.

2. The minor-surface sheet according to claim 1, wherein the print layer is formed by printing a pattern using an ink for gravure printing.

3. The minor-surface sheet according to claim 1, wherein the print layer is formed by deposition of metal.

4. A method for manufacturing a minor-surface sheet, comprising:
(a) preparing a transparent film layer;
(b) forming a print layer on a lower portion of the transparent film layer; and
(c) forming a transparent protrusion layer by attaching a plurality of transparent protrusions to an upper portion of the transparent film layer.

5. The method according to claim 4, wherein in the step (b), the print layer is formed by gravure printing.

6. The method according to claim 4, wherein in the step (b), the print layer is formed by metal deposition.

7. The method according to claim 4, wherein the step (c) comprises:
(c1) preparing a frame formed with grooves having shapes of the transparent protrusions, and filling the grooves with a liquid curable resin;
(c2) bring a surface of the frame having the grooves thereon into contact with the transparent film to allow the curable resin to be brought into contact with a surface of the transparent film; and
(c3) curing the curable resin in a state of contacting the transparent film.

8. The method according to claim 7, further comprising:
(c11) removing the curable resin from a portion of the surface of the frame, on which the grooves are not formed, between the step (c1) and the step (c2).

9. The method according to claim 4, wherein the step (c) comprises: forming a bonding layer on the transparent film layer and arranging the plurality of transparent protrusions on the bonding layer.
